(19) United States
(12) Patent Application Publication
(10) Pub. No.: US 2013/0271270 A1
(43) Pub. Date: Oct. 17, 2013

(54) RADIO FREQUENCY FOR CONSUMER ELECTRONICS BASED COMMUNICATION SYSTEM AND METHOD

(71) Applicants: Satish Nanjunda Swamy Jamadagni, Bangalore (IN); Dhinesh Rao Kumar, Bangalore (IN); Pavan Kumar Bhat, Bangalore (IN)

(72) Inventors: Satish Nanjunda Swamy Jamadagni, Bangalore (IN); Dhinesh Rao Kumar, Bangalore (IN); Pavan Kumar Bhat, Bangalore (IN)

(21) Appl. No.: 13/997,401

(22) PCT Filed: Dec. 23, 2011
(86) PCT No.: PCT/KR11/10055

§ 371 Date: Jun. 24, 2013

(30) Foreign Application Priority Data
Dec. 23, 2010 (IN) 3946/CHE/2010

(51) Int. Cl. H04L 29/06

(52) U.S. Cl. CPC H04L 29/0602
USPC 340/12.5

(57) ABSTRACT

A Radio Frequency for Consumer Electronics (RF4CE) based communication system and method is provided. The method includes discovering one or more controller devices in an RF4CE based radio communication network. The RF4CE based radio communication network includes one or more Consumer Electronics (CE) devices and one or more controller devices. The method also includes selecting one of the one or more controller devices based on capabilities of each of the one or more controller devices, transmitting an RF4CE data packet including Machine to Machine (M2M) communication data to the selected one of the one or more controller devices over an RF4CE protocol, such that the M2M communication data is forwarded to an intended external entity by the controller device via a communication channel.

### PRIORITY

This application is a National Stage application under 35 U.S.C. §371 of an International application filed on Dec. 23, 2011 and assigned application No. PCT/KR2011/010055, and claims the benefit under 35 U.S.C. §365(b) of a Indian patent application filed on Dec. 23, 2010 in the Indian Intellectual Property Office and assigned Serial No. 3946/CHE/2010, the entire disclosures of which are hereby incorporated by reference.

### BACKGROUND OF THE INVENTION

1. Field of the Invention

The present invention relates to the field of wireless communication system. More particularly, the present invention relates to Radio Frequency for Consumer Electronics (RF4CE) based communication system and method.

2. Description of the Related Art

Radio Frequency for Consumer Electronics (RF4CE) technology is designed to be deployed in wide range of remotely controlled Consumer Electronics devices in a home environment such as televisions, air conditioners, set-top boxes, audio equipments, and the like. RF4CE protocol allows for device-to-device communication and control in compliance with the Institute of Electrical and Electronics Engineers (IEEE) 802.15.4 standard.

Remote control devices conforming to (complying with) the RF4CE standard have replaced Infra-Red remote (IR) control devices and can operate CE devices freely from long distances regardless of obstacles, thereby overcoming a line of sight problem associated with IR remote control devices. For example, signal transmitter of an IR remote control device for a television according to the related art has to be pointed towards the receiver of the television in order to operate the television. In contrast, according to the related art, RF4CE remote control devices can operate a television set in a living room from a bedroom as such RF4CE remote control devices offer non-line of sight operation. Moreover, the RF4CE remote control device does not require a base station to communicate with consumer electronics devices.

Recent advancement has led to an evolution of mobile terminals, such as cellular phones, smart phones, Personal Digital Assistants (PDAs), and the like embedded with RF4CE feature and hence such mobile terminals acts as RF4CE remote control device and also as communication convergence device.

Machine-to-Machine (M2M) communication (also referred to as “machine-type communication” or “MTC”) is a form of data communication between devices (commonly known as MTC devices) that do not necessarily need human interaction unlike legacy devices. For example, in an M2M communication, a MTC device (such as a sensor or smart-meter) may capture an event data which is then relayed through a base station to an application residing in a MTC server for analysis and necessary action. M2M communication is used in a variety of areas such as smart metering systems (e.g., in applications related to power, gas, water, heating, grid control, and industrial metering), surveillance systems, order management, gaming machines, and health care communication.

The above information is presented as background information only to assist with an understanding of the present disclosure. No determination has been made, and no assertion is made, as to whether any of the above might be applicable as prior art with regard to the present invention.

### SUMMARY OF THE INVENTION

RF4CE technology according to the related art supports communication between RF4CE devices within an RF4CE based RF network. However, the RF4CE devices according to the related art are not intelligent enough to communicate information (e.g., health information) associated with the RF4CE device to an external entity (e.g., machine type communication server) or to receive instructions/messages from the external entity via the RF4CE remote control devices. Moreover, existing RF4CE remote control devices according to the related art do not support exchange of data/messages with the external entity over using existing wireless communication channels.

Aspects of the present invention are to address at least the above-mentioned problems and/or disadvantages and to provide at least the advantages described below. Accordingly, an aspect of the present invention is to provide a Radio Frequency for Consumer Electronics (RF4CE) based communication system and method.

Accordingly, aspects of the present invention solve the above-mentioned problems occurring in the related art. An aspect of the present invention is to provide radio frequency for Consumer Electronics (CE) based communication system and method.

In accordance with an aspect of the present invention, a method is provided. The method includes discovering one or more controller devices in an RF4CE based radio communication network. The RF4CE based radio communication network includes one or more CE devices and the one or more controller devices for managing the one or more CE devices. The method further includes selecting one of the one or more controller devices based on capabilities of the one of the one or more controller devices, and transmitting an RF4CE data packet including Machine to Machine (M2M) communication data to the selected one of the one or more controller devices over an RF4CE protocol such that the M2M communication data is forwarded to an intended external entity by the selected one of the one or more controller devices via a communication channel.

In accordance with an aspect of the present invention, a method is provided. The method includes receiving, by a mobile terminal, a request from a consumer electronics device in an RF4CE based radio communication network for forwarding M2M communication data to an external entity, receiving an RF4CE data packet including the M2M communication data from the CE device, and sending the M2M communication data received in the RF4CE data packet to the external entity via a communication channel.

In accordance with an aspect of the present invention, a method is provided. The method includes sending, by a mobile terminal, a request for M2M communication data to at least one CE device, receiving an RF4CE data packet including the M2M communication data from the at least one CE device, and sending the M2M communication data received in the RF4CE data packet to a desired external entity via a communication channel.

In accordance with an aspect of the present invention, an apparatus is provided. The apparatus includes a processor, memory coupled to the processor, and a transceiver coupled to the processor, wherein the memory includes an RF4CE profile module configured for discovering one or more controller devices in an RF4CE based radio communication network, selecting one of the one or more controller devices based on capabilities of the one of the one or more controller devices, and transmitting an RF4CE data packet including M2M communication data to the selected one of the one or more controller devices over an RF4CE protocol using the transceiver such that the selected one of the one or more controller devices forwards the M2M communication data to an intended server entity via a communication channel.

In accordance with an aspect of the present invention, an apparatus is provided. The apparatus includes a processor, memory coupled to the processor, wherein the memory comprises a forwarder, and a transceiver coupled to the processor, wherein the transceiver is configured for receiving an RF4CE data packet containing M2M communication data from at least one CE device in an RF4CE based radio communication network, and for processing the RF4CE data packet including the M2M communication data associated with the at least one CE device, and wherein the forwarder is configured for forwarding the M2M data received in the RF4CE data packet to the server entity via a communication channel.

In accordance with an aspect of the present invention, a system is provided. The system includes at least one consumer electronics device, at least one mobile terminal operatively connected to the at least one consumer electronics device via an RF4CE interface, and a server entity operatively connected to the at least one mobile terminal via at least one communication channel, wherein the at least one CE device is configured for detecting occurrence of an event and sending an RF4CE data packet including M2M communication data associated with the detected event to the at least one mobile terminal, and wherein at least one mobile terminal is configured for processing the RF4CE data packet including the M2M communication data and forwarding the M2M data associated with the event detected at the at least one CE device to the server entity via the at least one communication channel.

There is a need to provide radio frequency for CE based communication system and method.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF DRAWINGS

The above and other aspects, features, and advantages of certain exemplary embodiments of the present invention will be more apparent from the following description taken in conjunction with the accompanying drawings, in which:

FIG. 1 is a system diagram of a wireless communication system enabling communication of Machine to Machine (M2M) communication data between Consumer Electronics (CE) devices in a home environment and an external entity through a controller device using Radio Frequency for Consumer Electronics (RF4CE) protocol, according to an exemplary embodiment of the present invention.

FIG. 2 is a flow diagram illustrating an exemplary method of communicating M2M data associated with CE devices to an external entity, according to an exemplary embodiment of the present invention;

FIG. 3 is a flow diagram illustrating an exemplary method of communicating M2M data associated with CE devices to an external entity, according to another exemplary embodiment of the present invention;

FIG. 4 illustrates a block diagram of a CE device, such as, for example, the CE device shown in FIG. 1, according to an exemplary embodiment of the present invention; and

FIG. 5 illustrates a block diagram of a controller device, such as, for example, the controller device shown in FIG. 1, according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skilled in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The terms ‘Machine-to-Machine (M2M) communication data’ and ‘M2M data’ are used interchangeably throughout the document. The terms ‘Radio Communication (RC) network’ and ‘Radio Frequency for Consumer Electronics (RF4CE) based radio communication network’ are used interchangeably throughout the document. The terms ‘external entity’ and ‘server entity’ corresponds to the same entity.

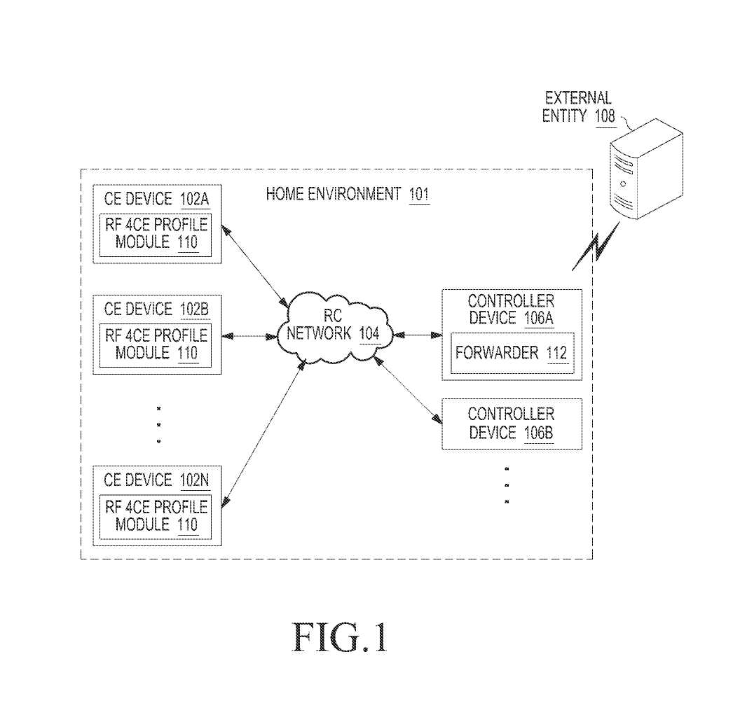

FIG. 1 is a system diagram of a wireless communication system enabling communication of Machine to Machine (M2M) communication data between Consumer Electronics (CE) devices in a home environment and an external entity through a controller device using Radio Frequency for Consumer Electronics (RF4CE) protocol, according to an exemplary embodiment of the present invention.

Referring to FIG. 1, the home environment 101 includes CE devices 102A-N and controller devices 106A-N. The CE devices 102A-N are connected to the controller devices 106A-N via an RC network 104.

The CE devices 102A-N includes television sets, washing machines, air conditioners, refrigerators, set top boxes, heaters and the like. Each of the CE devices 102A-N includes an RF4CE profile module 110 for communicating M2M communication data (e.g., data associated with health or operation of the CE devices 102A-N) with one of the controller devices via the RC network 104. The controller devices 106A-N include mobile terminals such as cellular phones, tablets, laptops, smart phones, Personal Digital Assistants (PDAs), digital cameras, portable game consoles, handheld e-books, Portable/Personal Multimedia players (PMPs), RF4CE remote control devices, and the like.

One or more of the controller devices 106A-N may have wireless communication capabilities for communicating with the external entity 108. For example, the controller device 106A includes a forwarder 112 which enables the controller device 106A to facilitate communication between the CE devices 102A-N and the external entity 108. Hence, the controller device 106A can be considered as capable of establishing wireless communication with the external entity 108 as well as sending/receiving M2M data to/from the CE devices 102A-N.

As illustrated in FIG. 1, the controller device 106B does not include a forwarder 112 installed therein. Accordingly, the controller device 106B is not capable of enabling communication between the CE devices 102A-N and the external entity 108.

The external entity 108 may be a web server, a machine type communication server, a user device acting as a server entity, and the like.

If the RF4CE profile module 110 in the CE device 102A detects an event that occurred at the CE device 102A, then, upon detection of the event, the RF4CE profile module 110 discovers one or more of the controller devices 106A-N connected to the CE device 102A (e.g., the RF4CE profile module determines the controller devices 106A-N that are connected to the CE device 102A). Then, the RF4CE profile module 110 sends a request for sharing capability information associated with the one or more of the controller devices 106A-N. Accordingly, the controller devices 106A-N shares the capability information with the CE device 102A. The RF4CE profile module 110 selects one of the controller devices 106A-N based on the capability information associated with each of the controller devices 106A-N. The capability information associated with each of the mobile terminals 106A-N indicates whether a particular mobile terminal supports M2M communication and whether said particular mobile terminal is connected to the M2M server 108 via one of available communication channels.

For the purpose of illustration below, the CE device 102A is assumed to select the controller device 106A because the controller device 106A includes the forwarder 112.

The RF4CE profile module 110 thus sends an RF4CE data packet including M2M communication data associated with the detected event to the controller device 106A. The forwarder 112 in the controller device 106A retrieves the M2M communication data from the RF4CE data packet and encapsulates the M2M communication data in an IP data packet. Then, the forwarder 112 transmits the IP data packet including the M2M communication data to the external entity 108 for further processing and analysis. The CE device 102A may communicate the CE device's M2M capabilities and information associated with the external entity 108 to the controller devices 106A-N prior to occurrence of the event so that the controller device 106A can send the M2M data to the appropriate external entity 108. The external entity 108 may send a response message in response to the M2M data to the controller device 106A. The controller device 106A processes the response message and forwards the processed response message to the CE device 102A.

According to exemplary embodiments, the controller device 106A may request one or more CE devices 106A-N to provide associated M2M data. Based on the request, the respective CE devices 102A-N may send the associated M2M data to the controller device 106A over the RC network 104. The forwarder 112 may then transmit the M2M data associated with respective CE devices 102A-N to the external entity 108. It is understood that, although FIG. 1 illustrates single external entity 108, multiple external entities may be connected to the controller devices 106-N in the wireless communication system 100.

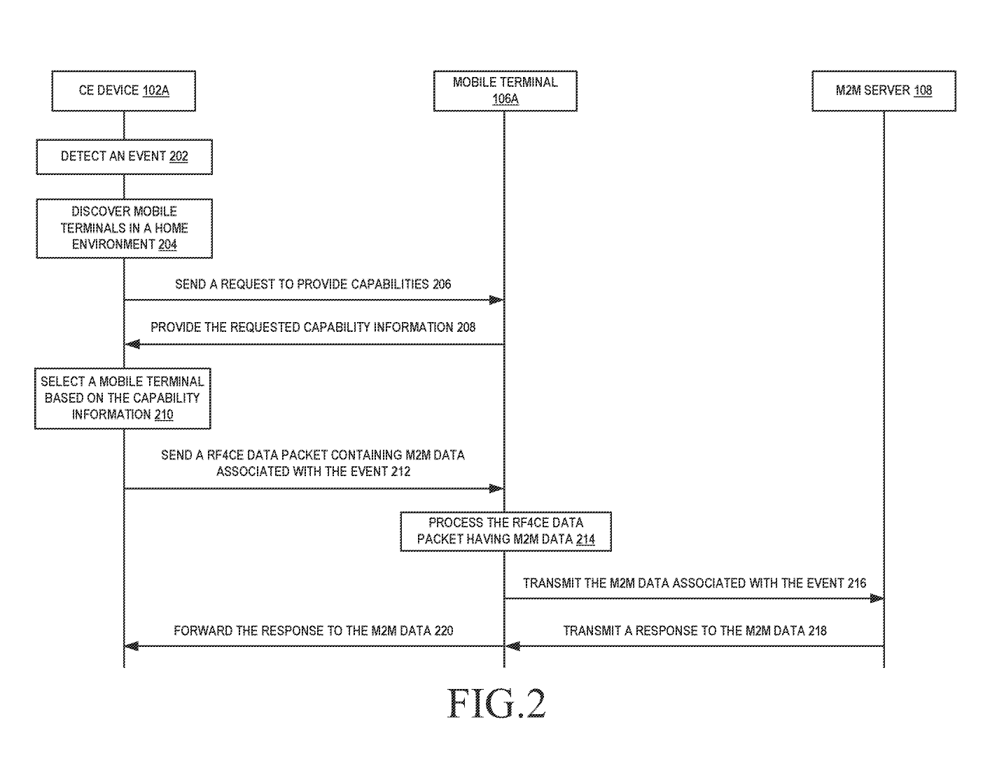

FIG. 2 is a flow diagram illustrating an exemplary method of communicating M2M data associated with CE devices 102A-N to an external entity 108, according to an exemplary embodiment of the present invention.

Referring to FIG. 2, communication between the CE device 102A, the controller device 106A (e.g., mobile terminal) and an external entity 108 (e.g., a M2M server) is depicted for the purpose of illustration.

At step 202, the CE device 102A detects occurrence of an event.

At step 204, the CE device 102A discovers one or more mobile terminals in a home environment upon detecting the event.

At step 206, the CE device 102A sends, to the discovered mobile terminal 106A, a request to provide capabilities.

At step 208, the discovered mobile terminal 106A share the capability information with the CE device 102A. For example, upon receipt of the request to provide capabilities from the CE device 102A, the discovered mobile terminal 106A-N transmit the capability information to the CE device 102A. The capability information associated with each of the mobile terminals 106A-N indicate whether a particular mobile terminal supports M2M communication and whether said particular mobile terminal is connected to the M2M server 108 via one of available communication channels.

At step 210, the CE device 102A selects the mobile terminal 106A for forwarding the M2M communication data associated with the event to the M2M server 108 based on the capability information associated with the mobile terminal 106A. For example, the mobile terminal 106A supports M2M communication and is connected to the M2M server 108 via one of the available communication channels. Hence, the CE device 102A has selected the mobile terminal 106A among the mobile terminals 106A-N for forwarding M2M communication data to the M2M server 108.

At step 212, the CE device 102A transmits an RF4CE data packet including the M2M communication data associated with the detected event to the mobile terminal 106A.

At step 214, the mobile terminal 106A processes the RF4CE data packet including M2M communication data. According to an exemplary embodiment of the present invention, the mobile terminal 106A retrieves the M2M communication data from the RF4CE data packet and encapsulates the M2M communication data in an Internet Protocol (IP) data packet.

At step 216, the mobile terminal 106A sends the IP data packet with the M2M communication data to the M2M server 108. According to an exemplary embodiment of the present invention, the CE device 102A has communicated the CE device's M2M capabilities and information (e.g., IP address) associated with the M2M server 108 prior to occurrence of the event. Therefore, the mobile terminal 106A is aware of the intended M2M server 108 with which the M2M communication data associated with the event is to be shared.

At step 218, the M2M server 108 sends a response to the M2M communication data to the mobile terminal 106A.

At step 220, the mobile terminal 106A forwards the response to the M2M data to the CE device 102A.

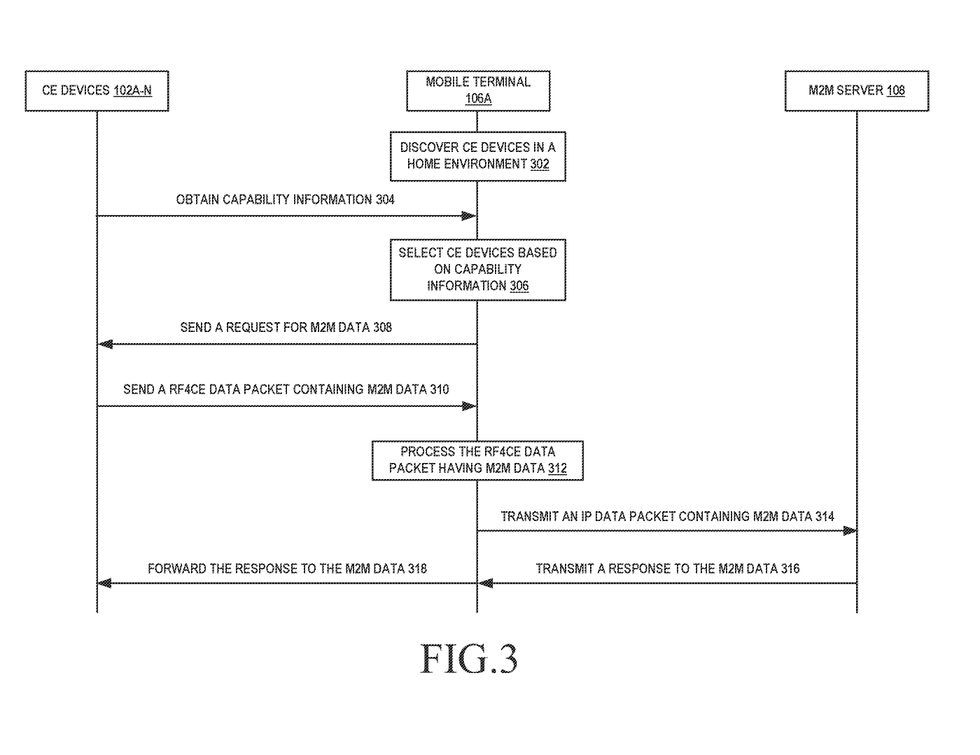

FIG. 3 is a flow diagram illustrating an exemplary method 300 of communicating M2M data associated with CE devices 102A-N to an external entity 108, according to another exemplary embodiment of the present invention.

Referring to FIG. 3, communication between the CE devices 102A-N, the controller device 106A (e.g., mobile terminal), and the external entity 108 (e.g., a M2M server) is depicted for the purpose of illustration.

At step 302, the mobile terminal 106A discovers one or more CE devices 102-N in a home environment.

At step 304, the mobile terminal 106A obtains capability information of the CE devices 102A-N. The capability information associated with each of the CE devices 102A-N indicates whether a particular CE device supports M2M communication. For example, the mobile terminal 106A receives the corresponding capability information of the CE devices 102A-N from each of the CE devices 102A-N.

At step 306, the mobile terminal 106A selects one or more of the CE devices 102A-N based on the capability information associated with the one or more of the CE devices 102A-N. For the purpose of illustration, the mobile terminal 106A is assumed to select the CE device 102A based on the capability information of the CE device 102A.

At step 308, the mobile terminal 102A sends a request for M2M communication data to the CE device 102A.

Accordingly, at step 310, the CE device 102A transmits an RF4CE data packet including the M2M communication data to the mobile terminal 106A.

At step 312, the mobile terminal 106A processes the RF4CE data packet including M2M communication data. According to an exemplary embodiment of the present invention, the mobile terminal 106A retrieves the M2M communication data from the RF4CE data packet and encapsulates the M2M communication data in an Internet Protocol (IP) data packet.

At step 314, the mobile terminal 106A sends the IP data packet with the M2M communication data to the M2M server 108. According to an exemplary embodiment of the present invention, the CE device 102A has communicated information (e.g., IP address) associated with the M2M server 108 prior to the request for the M2M communication data. Therefore, the mobile terminal 106A is aware of the intended M2M server 108 with which the M2M communication data is to be shared.

At step 316, the M2M server 108 sends a response to the M2M communication data to the mobile terminal 106A.

At step 318, the mobile terminal 106A forwards the response to the M2M data to the CE device 102A.

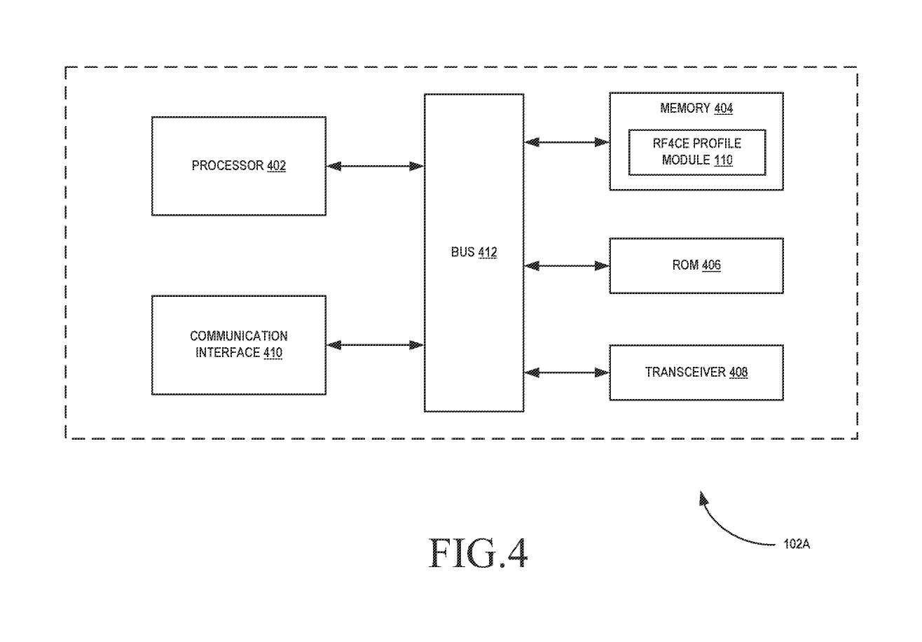

FIG. 4 illustrates a block diagram of a CE device, such as, for example, the CE device shown in FIG. 1, according to an exemplary embodiment of the present invention.

Referring to FIG. 4, the CE device 102A includes a processor 402, memory 404, a Read Only Memory (ROM) 406, a transceiver 408, a communication interface 410, and a bus 412.

The processor 402, as used herein, may correspond to any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a graphics processor, a digital signal processor, or any other type of processing circuit. The processor 402 may also include embedded controllers, such as generic or programmable logic devices or arrays, application specific integrated circuits, single-chip computers, smart cards, and the like.

The memory 404 may be volatile memory and non-volatile memory. The memory 404 includes the RF4CE profile module 110 stored in the form of instructions, that when executed by the processor 402, cause the processor 402 to communicate M2M communication data with the external entity 108 via the controller device 106A using RF4CE protocol, according to the exemplary embodiments of the present invention. A variety of non-transitory computer-readable storage media may be stored in and accessed from the memory elements. Memory elements may include any suitable memory device(s) for storing data and machine-readable instructions, such as read only memory, random access memory, erasable programmable read only memory, electrically erasable programmable read only memory, hard drive, removable media drive for handling memory cards, Memory Sticks™, and the like.

Exemplary Embodiments of the present invention may be implemented in conjunction with modules, including functions, procedures, data structures, and application programs, for performing tasks, or for defining abstract data types or low-level hardware contexts. Machine-readable instructions stored on any of the above-mentioned storage media may be executable by the processor 402. For example, a computer program may include machine-readable instructions capable of communicating M2M communication data with the external entity 108 via the controller device 106A using RF4CE protocol, according to the teachings and herein described exemplary embodiments of the present invention. According to an exemplary embodiment of the present invention, the computer program may be included on a storage medium and loaded from the storage medium to a hard drive in the non-volatile memory. The transceiver 408 is configured for transmitting an RF4CE data packet containing M2M communication data with one of the mobile terminals 106A-N using RF4CE protocol.

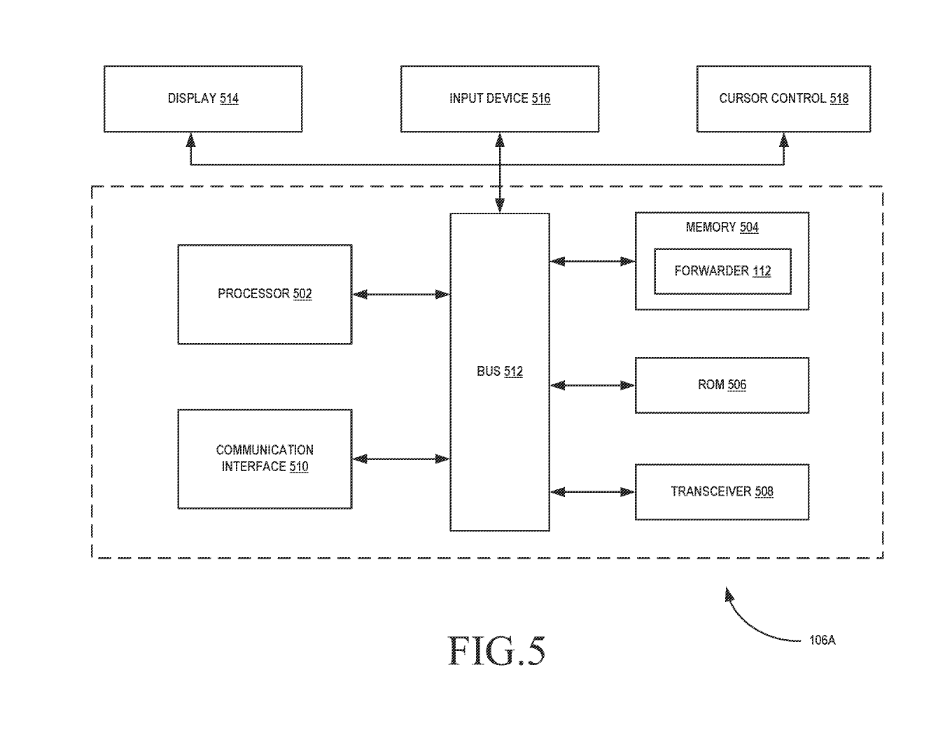

FIG. 5 illustrates a block diagram of a controller device, such as, for example, the controller device shown in FIG. 1, according to an exemplary embodiment of the present invention.

Referring to FIG. 5, the controller device 106A includes a processor 502, memory 504, a Read Only Memory (ROM) 506, a transceiver 508, a communication interface 510, a bus 512, a display 514, an input device 516, and a cursor control 518.

The processor 502, as used herein, may correspond to any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a graphics processor, a digital signal processor, or any other type of processing circuit. The processor 502 may also include embedded controllers, such as generic or programmable logic devices or arrays, application specific integrated circuits, single-chip computers, smart cards, and the like.

The memory 504 may be volatile memory and non-volatile memory. The memory 504 includes the forwarder 112 stored in the form of machine-readable instructions, than when executed by the processor 502, cause the processor 502 to process M2M communication data (e.g., in an RF4CE data packet) received from the CE devices 102A-N and to forward the processed M2M communication data to the external entity 108, according to the exemplary embodiments of the present invention. A variety of non-transient computer-readable storage media may be stored in and accessed from the memory elements. Memory elements may include any suitable memory device(s) for storing data and machine-readable instructions, such as read only memory, random access memory, erasable programmable read only memory, electrically erasable programmable read only memory, hard drive, removable media drive for handling memory cards, Memory Sticks™, and the like.

Exemplary embodiments of the present invention may be implemented in conjunction with modules, including functions, procedures, data structures, and application programs, for performing tasks, or defining abstract data types or low-level hardware contexts. Machine-readable instructions stored on any of the above-mentioned storage media may be executable by the processor 502. For example, a computer program may include machine-readable instructions capable of processing M2M communication data (e.g., in an RF4CE data packet) received from the CE devices 102A-N and forward the M2M communication data to the external entity 108, according to the teachings and herein described exemplary embodiments of the present invention. According to an exemplary embodiment of the present invention, the computer program may be included on a storage medium and loaded from the storage medium to a hard drive in the non-volatile memory.

The transceiver 508 is configured for transmitting the processed M2M communication data to the external entity 108 using one of the communication channels.

While the invention has been shown and described with reference to certain exemplary embodiments thereof, it will be understood by those skilled in the art that various changes in form and details may be made therein without departing from the spirit and scope of the invention as defined by the appended claims and their equivalents.

1. A method comprising:
discovering one or more controller devices in a Radio Frequency for Consumer Electronics (RF4CE) based radio communication network, wherein the RF4CE based radio communication network comprises one or more Consumer Electronics (CE) devices and the one or more controller devices for managing the one or more CE devices;
selecting one of the one or more controller devices based on capabilities of the one of the one or more controller devices; and
transmitting an RF4CE data packet including Machine to Machine (M2M) communication data to the selected one of the one or more controller devices over an RF4CE protocol such that the M2M communication data is forwarded to an intended external entity by the selected one of the one or more controller devices via a communication channel.

2. The method of claim 1, wherein the selected one of the one or more controller devices is a mobile terminal having M2M communication capability with the intended external entity.

3. The method of claim 1, wherein the intended external entity is selected from a group comprising a web server, a machine type communication server, and a user device.

4. The method of claim 1, wherein the selecting of the one of the one or more controller devices based on the capabilities of the one of the one or more controller devices comprises:
obtaining capabilities of the one or more controller devices by performing a capability exchange procedure; and
selecting one of the one or more controller devices based on the capabilities of the one of the one or more controller devices.

5. The method of claim 1, further comprising:
communicating M2M capabilities of the CE device and information associated with the intended external entity to the selected one of the one or more controller devices.

6. The method of claim 1, wherein the discovering of the one or more controller devices in the RF4CE based radio communication network comprises:
detecting an event associated with the CE device; and
discovering the one or more controller devices in the RF4CE based radio communication network upon detecting the event.

7. A method comprising:
receiving, by a mobile terminal, a request from a Consumer Electronics (CE) device in a Radio Frequency for Consumer Electronics (RF4CE) based radio communication network for forwarding Machine to Machine (M2M) communication data to an external entity;
receiving an RF4CE data packet including the M2M communication data from the CE device; and
sending the M2M communication data received in the RF4CE data packet to the external entity via a communication channel.

8. The method of claim 7, wherein the sending of the M2M communication data received in the RF4CE data packet to the external entity via the communication channel comprises:
retrieving the M2M communication data from the RF4CE data packet;
encapsulating the M2M communication data in an Internet Protocol (IP) data packet; and
sending the IP data packet with the M2M communication data to the external entity via the communication channel.

9. The method of claim 7, wherein the receiving of the request for forwarding M2M from the CE device comprises:
receiving a request for sharing M2M communication capabilities from the CE device;
sharing M2M communication capabilities of the controller device with the CE device; and
receiving the request for forwarding M2M communication data from the CE device in response to the shared M2M capabilities.

10. The method of claim 7, wherein the external entity is selected from a group comprising a web server, a machine type communication server, and a user device.

11. The method of claim 7, further comprising:
receiving M2M capabilities of the CE device and information associated with the external entity from the CE device.

12. The method of claim 7, further comprising:
receiving a response from the external entity in response to the M2M communication data associated with the CE device; and
forwarding the response received from the external entity to the CE device.

13. A method comprising:
sending, by a mobile terminal, a request for Machine to Machine (M2M) communication data to at least one Consumer Electronics (CE) device;
receiving a Radio Frequency for Consumer Electronics (RF4CE) data packet including the M2M communication data from the at least one CE device; and
sending the M2M communication data received in the RF4CE data packet to a desired external entity via a communication channel.

14. The method of claim 13, further comprising:
discovering one or more CE devices in an RF4CE based radio communication network;
obtaining M2M capabilities associated with each of the one or more CE devices; and
selecting at least one of the one or more CE devices for obtaining associated M2M communication data based on the M2M communication capabilities of each of the one or more CE devices.

15. The method of claim 13, wherein the desired external entity is selected from a group comprising a web server, a machine type communication server, and a user device.

16. The method of claim 13, further comprising:
obtaining information associated with the desired external entity from the at least one CE device.

17. The method of claim 13, wherein the sending of the M2M communication data received in the RF4CE data packet to the desired external entity via the communication channel comprises:
retrieving the M2M communication data from the RF4CE data packet;
encapsulating the M2M communication data in an Internet Protocol (IP) data packet; and
sending the IP data packet with the M2M communication data to the desired external entity via the communication channel.

18. The method of claim 13, further comprising:
receiving a response from the desired external entity in response to the M2M communication data associated with the at least one CE device; and
forwarding the response received from the external entity to the at least one CE device.

19. An apparatus comprising:
a processor;
memory coupled to the processor; and
a transceiver coupled to the processor,
wherein the memory includes a Radio Frequency for Consumer Electronics (RF4CE) profile module configured for:
discovering one or more controller devices in an RF4CE based radio communication network;
selecting one of the one or more controller devices based on capabilities of the one of the one or more controller devices; and
transmitting an RF4CE data packet including Machine to Machine (M2M) communication data to the selected one of the one or more controller devices over an RF4CE protocol using the transceiver such that the selected one of the one or more controller devices forwards the M2M communication data to an intended server entity via a communication channel.

20. The apparatus of claim 19, wherein the RF4CE profile module is configured for:
obtaining capabilities of the one or more controller devices by performing a capability exchange procedure; and
selecting one of the one or more controller devices based on the capabilities of the one of the one or more controller devices.

21. The apparatus of claim 19, wherein the RF4CE profile module is configured for communicating M2M capabilities and information associated with the intended server entity to the selected one of the one or more controller devices.

22. The apparatus of claim 19, wherein the RF4CE profile module is configured for discovering the one or more controller devices in the RF4CE based radio communication network upon occurrence of an event.

23. An apparatus comprising:
a processor;
memory coupled to the processor, wherein the memory comprises a forwarder; and
a transceiver coupled to the processor,
wherein the transceiver is configured for receiving a Radio Frequency for Consumer Electronics (RF4CE) data packet including Machine to Machine (M2M) communication data from at least one Consumer Electronics (CE) device in an RF4CE based radio communication network, and
wherein the forwarder is configured for processing the RF4CE data packet including the M2M communication data associated with the at least one CE device, and for forwarding the M2M data received in the RF4CE data packet to the server entity via a communication channel.

24. The apparatus of claim 23, wherein the forwarder is configured for:
discovering one or more CE devices in the RF4CE based radio communication network;
obtaining M2M capabilities associated with each of the one or more CE devices;
selecting at least one of the one or more CE devices for obtaining associated M2M communication data based on the M2M communication capabilities of the at least one of the one or more CE devices; and
requesting the at least one CE device to provide M2M communication data.

25. The apparatus of claim 24, wherein the transceiver is configured for receiving an RF4CE data packet including the M2M communication data from the at least one CE device in response to the request for M2M communication data.

26. The apparatus of claim 23, wherein the transceiver is configured for receiving a request for M2M communication capabilities from the at least one CE device.

27. The apparatus of claim 26, wherein the forwarder is configured for providing the M2M communication capabilities with the at least one CE device in response to the request for the M2M communication capabilities.

28. The apparatus of claim 27, wherein the transceiver is configured for receiving a request from the at least one CE device to forward M2M communication data to the server entity.

29. The apparatus of claim 28, wherein the forwarder is configured for obtaining information associated with the server entity from the at least one CE device.

30. The apparatus of claim 23, wherein in processing the RF4CE data packet including the M2M communication data, the forwarder is configured for:
retrieving the M2M communication data from the RF4CE data packet;
encapsulating the M2M communication data in an Internet Protocol (IP) data packet; and
sending the IP data packet with the M2M communication data to the server entity via the communication channel.

31. The apparatus of claim 30, wherein the transceiver is configured for:
receiving a response from the server entity in response to the M2M communication data associated with the at least one CE device; and
forwarding the response received from the server entity to the at least one CE device.

32. A system comprising:
at least one Consumer Electronics (CE) device;
at least one mobile terminal operatively connected to the at least one CE device via a Radio Frequency for Consumer Electronics (RF4CE) (RF4CE) interface; and
a server entity operatively connected to the at least one mobile terminal via at least one communication channel,
wherein the at least one CE device is configured for detecting occurrence of an event and sending an RF4CE data packet including Machine to Machine (M2M) communication data associated with the detected event to the at least one mobile terminal, and
wherein at least one mobile terminal is configured for processing the RF4CE data packet including the M2M communication data and forwarding the M2M data associated with the event detected at the at least one CE device to the server entity via the at least one communication channel.

33. The system of claim 32, wherein the server is configured for sending a response to the M2M communication data to the at least one mobile terminal via the at least one communication channel.

34. The system of claim 33, wherein the at least one mobile terminal is configured for forwarding the response associated with the M2M communication data to the at least one consumer electronics device.

35. The system of claim 33, wherein the at least one CE device is configured for:
discovering the at least one mobile terminal in an RF4CE based radio communication network upon detecting the event;
obtaining capabilities of the at least one mobile terminal from the at least one mobile terminal; and
sending an RF4CE data packet including M2M communication data associated with the detected event to the at least one mobile terminal based on the capabilities of the at least one mobile terminal.

36. The system of claim 33, wherein the at least one mobile terminal is configured for sending a request for providing M2M data to the at least one CE device.
